(19) United States
(12) Patent Application Publication
(10) Pub. No.: US 2011/0194820 A1
(43) Pub. Date: Aug. 11, 2011

(54) OPTICAL MODULE AND METHOD OF ASSEMBLING THE SAME

(76) Inventors: Wataru Sakurai, Kanagawa (JP); Mitsuaki Tamura, Kanagawa (JP)

(21) Appl. No.: 12/671,827

(22) PCT Filed: Apr. 3, 2009
(86) PCT No.: PCT/JP2009/056990

§ 371 Date: Feb. 2, 2010

(30) Foreign Application Priority Data
Apr. 4, 2008 (JP) 2008-098139

(51) Int. Cl. G02B 6/42; H01S 4/00

(52) U.S. Cl. 385/88; 29/592.1

(57) ABSTRACT

An optical module is obtained in which a photoelectric converting element can be fixed by a highly reliable resin material while the resin material can be prevented from intruding into an optical path and the transparency of the optical path is ensured.

An optical module 100 includes a photoelectric converting element 31, and an optical ferrule 33 in which the photoelectric converting element 31 is equipped on one end face 43, and an optical fiber through hole 45 is passed and formed at a position corresponding to an active layer 39 of the photoelectric converting element 31, a resin material 49 being filled and cured between the photoelectric converting element 31 and the optical ferrule 33, wherein an opening portion 51 of the optical fiber through hole 45 is covered by a transparent substance 53 which is contacted with the active layer 39, and which blocks intrusion of the resin material 49, the opening portion 51 being formed in the one end face 43 of the optical ferrule 33. The transparent substance 53 may be a sheet or grease. The sheet or the grease may be disposed individually correspondingly on the respective plural optical fiber through holes 45.

### RELATED APPLICATIONS

This application is the U.S. National Phase under 35 U.S.C. §371 of International Application No. PCT/JP2009/056990, filed on Apr. 3, 2009, which in turn claims the benefit of Japanese Application No. 2008-098139, filed on Apr. 4, 2008, the disclosures of which Applications are incorporated by reference herein.

### TECHNICAL FIELD

The present invention relates to an optical module which directly optically couples an optical fiber with a photoelectric converting element, and a method of assembling it, and more particularly to a technique for improving a resin material filled structure in a gap between a photoelectric converting element and an optical ferrule.

### BACKGROUND ART

In accordance with speeding-up of a signal between LSIs, in electrical transmission, it becomes difficult to eliminate noises and increase of power consumption. Recently, therefore, attempts in which transmission between LSIs is conducted by optical communication that is substantially free from electromagnetic interference and a frequency-dependent loss have been performed. For example, a photoelectric conversion header (optical module) disclosed in Patent Reference 1 includes a light emitting element (for example, a VCSEL: Vertical Cavity Surface Emitting Laser) or a light receiving element (photoelectric converting element), and a lead-insert molded ferrule which is equipped with the photoelectric converting element, and into which an optical fiber is to be inserted, so that the photoelectric converting element and the optical fiber can be directly optically coupled with each other.

In an optical module 1, as shown in FIG. 5, a lead-insert molded ferrule 3 has through holes (optical fiber through holes) 7 into which optical fibers (or optical waveguides) 5 are to be inserted, and a photoelectric converting element 9 is equipped so as to be positioned by inserting the optical fibers 5. In the figure, 11 denotes electric wirings (extraction electrodes) which are pattern-formed on the ferrule 3, 13 denotes Au bumps, 15 denotes a transparent resin which is an optical element underfill material and an adhesive agent for the optical fibers, and 17 denotes active layers.

In production of the optical module 1, as shown in FIG. 6(a), the photoelectric converting element 9 is first mounted on the ferrule 3 having the electrodes 11 and an optical element mounting face. Connection to the electrodes 11 is performed by using, for example, thermal pressure boding of the Au bumps 13. As shown in FIG. 6(b), next, the optical fibers 5 are inserted into the ferrule 3. In the insertion of the optical fibers 5, an apparatus which can monitor the insertion pressure, such as a micrometer having a pressure sensor is used, and the insertion of the optical fibers 5 is stopped at a point where an insertion pressure corresponding to a predetermined insertion distance is applied to the optical fibers 5. As shown in FIG. 6(c), finally, the transparent resin 15 configured by a thermosetting resin or an ultraviolet curable resin is cured.

The optical module 1 which is configured by inserting the optical fibers 5 as described above is mounted on, for example, a mounting board 18 which functions also as a heat sink, and connected with an optical-element driver IC (such as a driver or a receiver) which is not shown, through bonding wires to be incorporated onto a circuit board. According to the optical module 1, the optical fibers 5 are directly inserted and connected to the ferrule 3 which is mounted on the board, and hence miniaturization and cost reduction can be expected.

### PRIOR ART REFERENCE

### Patent Reference

Patent Reference 1: Japanese Patent Publication: JP-A-2006-59867

### SUMMARY OF THE INVENTION

### Problems that the Invention is to Solve

Reflected light from an end face of an optical fiber is sometimes coupled to the optical resonance mode of a VCSEL to generate return optical noise. In the conventional optical module 1, in order to suppress the problem, the transparent substance 15 which is close in refractive index to the optical fibers 5 is filled into a gap between the optical fibers 5 and the photoelectric converting element (VCSEL) 9. The transparent resin 15 has also an effect that the optical fibers 5 are prevented from being minutely vibrated by an external force. The transparent resin 15 has a further effect that the resin buffers the difference in coefficient of thermal expansion between the photoelectric converting element 9 and the ferrule 3. Therefore, it is disclosed that the transparent resin 15 is mixed with a transparent fine grain filler (for example, silica or crushed quarts having a mean particle diameter of from several μm to several tens of μm). Namely, it is described that the mixing rate of the transparent fine grain filler is adjusted so that the average or equivalent thermal expansion characteristics of the transparent resin 15 conform to those of the optical fiber 5 and the photoelectric converting element 9 or are defined as their intermediate value, thereby allowing an increase in a thermal stress (thermal strain) relieving effect.

In the optical module 1, however, interference between the active layers 17 and the optical fibers 5 is avoided only by an inclined structure, and the transparent resin 15 does not exist before a step of inserting the optical fibers 5. In the case where an end face of a connection end 5a is formed by cleavage in which an incision 19 is formed in the optical fiber 5 and the fiber is cut by applying bending stress, therefore, there remains the possibility that, as shown in, for example, FIG. 7, a projection 21 produced in the connection end 5a, a protrusion after polishing of the connection end face, or the like interferes with the active layers 17. Namely, there is a fear that no shield member is interposed with respect to the active layers 17. Because of this also, the insertion and stop of the optical fibers 5 must be strictly managed as described above, and the assembly workability of the optical fibers 5 is lowered.

By contrast, when the transparent resin 15 is filled before insertion of the optical fibers 5, the transparent resin 15 intrudes into opening portions of the optical fiber through holes 7, and the optical fibers 5 cannot be inserted. The transparent resin 15 must be equivalent in refractive index to the optical fibers 5, while exerting functions as a reinforcing member against an external force, and also as an adjusting member for enhancing the thermal stress (thermal strain) relieving effect. In the case of a mixture with a fine grain filler, when these are formed by the same materials, the degree of freedom in material selection is lowered.

Since no shield member is interposed with respect to the active layers 17, the optical module 1 is not suitable as a later-optical-fiber-assembling optical module into which the optical fibers 5 are to be inserted by the user.

The invention has been conducted in view of the above-discussed circumstances. It is an object of the invention to provide an optical module in which a photoelectric converting element can be fixed by a highly reliable resin material while the resin material can be prevented from intruding into an optical path and the transparency of the optical path is ensured, and which can be used also as a later-optical-fiber-assembling optical module, and a method of assembling the optical module.

### Means for Solving the Problems

The object of the invention is attained by the following configurations.

(1) An optical module includes: a photoelectric converting element; and an optical ferrule in which the photoelectric converting element is equipped on one end face, and an optical fiber through hole is passed and formed at a position corresponding to an active layer of the photoelectric converting element, a resin material being filled and cured between the photoelectric converting element and the optical ferrule, wherein

an opening portion of the optical fiber through hole is covered by a transparent substance which is contacted with the active layer, and which blocks intrusion of the resin material, the opening portion being formed in the one end face of the optical ferrule.

According to the optical module, the chip reinforcement resin material (adhesive agent) which is to be applied in a post process can be prevented from intruding into an optical path. Since the transparent substance is contacted with the active layer and covers the opening portion, the optical path is ensured between the optical fiber and the active layer, and the chip reinforcement resin material is not required to have transparency.

(2) In the optical module according to (1), the transparent substance is a sheet or grease.

According to the optical module, the work of attaching the transparent substance to the opening portion is facilitated. When the substance is a sheet, easy attachment due to an adhesive layer is enabled. When the substance is grease, easy attachment due to application is enabled. Furthermore, an impact in an inserting and assembling process can be absorbed by the elasticity of the sheet or grease.

(3) In the optical module according to (2), the optical fiber through hole is formed in plural, and the sheet or the grease is disposed individually correspondingly on the respective plural optical fiber through holes.

According to the optical module, a space is formed between the sheets or greases which cover the optical fiber through holes, and the space is filled with the resin material. Therefore, the bonding area between the photoelectric converting element and the optical ferrule can be increased, and the fixing strength can be enhanced.

(4) In the optical module according to (2), the optical fiber through hole is formed in plural, and the sheet or the grease is commonly disposed on the plural optical fiber through holes.

According to the optical module, the plurality of optical fiber through holes can be covered at one time by one sheet or grease, and the assembling work is facilitated.

(5) In the optical module according to any one of (1) to (4), an optical fiber is passed through the plural optical fiber through hole.

According to the optical module, the optical fiber butts against the active layer through the transparent substance, and it is possible to obtain a highly reliable optical-fiber assembled optical module in which the active layer is not broken by butting of the tip end of the optical fiber.

(6) In the optical module according to any one of (1) to (5), bumps of the photoelectric converting element are passed through the transparent substance and electrically connected to electrodes which are formed on the one end face of the optical ferrule.

According to the optical module, the position where the transparent substance is attached is not restricted, and the workability is improved. For example, the transparent substance may be attached to the whole area of one end face of the optical ferrule. In this case, the resin material is disposed so as to cover the gap between the photoelectric converting element and the optical ferrule.

(7) In the optical module according to any one of (1) to (6), the resin material is an adhesive agent into which an adjusting grain material that suppresses a coefficient of thermal expansion is mixed.

According to the optical module, the mixing rate of the resin material and the adjusting grain material is adjusted so that the average or equivalent thermal expansion characteristics of the resin material conform to those of the optical fiber and the photoelectric converting element or are defined as their intermediate value, thereby allowing an increase in a thermal stress (thermal strain) relieving effect.

(8) In the optical module according to any one of (1) to (7), a whole of the photoelectric converting element, and a part of at least the optical ferrule including a gap between the photoelectric converting element and the optical ferrule are covered by a mold resin.

According to the optical module, the mold resin covers over the photoelectric converting element and the optical ferrule, and the photoelectric converting element, the optical ferrule, and the optical fiber are formed into an integral fixed structure which is stronger.

(9) In the optical module according to (8), the mold resin is the resin material.

According to the optical module, while a single resin material is used, filling of the gap between the photoelectric converting element and the optical ferrule, and mold covering over the photoelectric converting element and the optical ferrule are enabled, and the kinds of used resin materials, and the number of production steps can be reduced.

(10) A method of assembling an optical module, performs the steps:

covering an opening portion of an optical fiber through hole formed in one end face of the optical ferrule, by a transparent substance;
connecting and fixing a photoelectric converting element to the one end face of the optical ferrule; and
filling a resin material between the photoelectric converting element and the one end face of the optical ferrule.

According to the method of assembling an optical module, even when the resin material is filled, the resin material is blocked by the transparent substance, and does not intrude into the optical fiber through hole. Since the opening portion is covered by the transparent substance, the filling of the resin material can be performed without regard to the intrusion, and a high fixation strength can be obtained.

(11) A method of assembling an optical module, performs the steps:

covering an opening portion of an optical fiber through hole formed in one end face of the optical ferrule, by a transparent substance;
connecting and fixing a photoelectric converting element to the one end face of the optical ferrule;
inserting an optical fiber into the optical fiber through hole; and
covering a whole of the photoelectric converting element, and a part of at least the optical ferrule including a gap between the photoelectric converting element and the optical ferrule, by a mold resin.

According to the method of assembling an optical module, even when the resin material is filled, the resin material is blocked by the transparent substance, and does not intrude into the optical fiber through hole. Since the opening portion is covered by the transparent substance, the filling of the resin material can be performed without regard to the intrusion, and a high fixation strength can be obtained. It is possible to obtain a highly reliable optical-fiber-assembled optical module in which the optical fiber butts against the active layer through the transparent substance, and the active layer is not broken by butting of the tip end of the optical fiber. The photoelectric converting element, the optical ferrule, and the optical fiber can be formed into an integral fixed structure which is stronger.

### Effects of the Invention

According to the optical module of the invention, the opening of the optical fiber through hole which is formed in one end face of the optical ferrule is covered by the transparent substance that is contacted with the active layer to block intrusion of the resin material, and hence the chip reinforcement resin material (adhesive agent) which is to be applied in a post process can be prevented from intruding into the optical path. For the purpose of ensuring the reliability, the resin material contains the adjusting grain material which suppresses the coefficient of thermal expansion, and, in view of ensuring a high reliability, is not required to be transparent. Therefore, the degree of freedom in material selection is enhanced. Since the transparent substance is interposed between the active layer and the opening portion, the photoelectric converting element can be fixed by the highly reliable resin material while ensuring the transparency of the optical path. Since the transparent substance is disposed in the opening portion, element breakage caused by butting of the optical fiber against the active layer can be prevented from occurring, even when the optical module is used as a later-optical-fiber-assembling optical module into which the optical fiber is to be inserted by the user.

According to the method of assembling an optical module of the invention, the opening of the optical fiber through hole which is formed in one end face of the optical ferrule is covered by the transparent substance, the photoelectric converting element is connected and fixed to the one end face of the optical ferrule, and thereafter the resin material is filled between the photoelectric converting element and the one end face of the optical ferrule. Even when the resin material is filled, therefore, the resin material is blocked by the transparent substance, and does not intrude into the optical fiber through hole. As a result, it is possible to obtain a later-optical-fiber-assembling optical module in which a photoelectric converting element is fixed by a highly reliable resin material while ensuring the transparency of the optical path.

### BRIEF DESCRIPTION OF THE DRAWINGS

FIG. 1 is a sectional view of the optical module of the invention.

FIG. 2 is a front view showing in (a) and (b) an example of a transparent substance which is attached to one end face of the optical module shown in FIG. 1.

FIG. 3 is a production step diagram illustrating a method of assembling the optical module shown in FIG. 1.

FIG. 4 is a sectional view of a modification in which a resin material is used as the mold resin.

FIG. 5 is a sectional view of the conventional optical module.

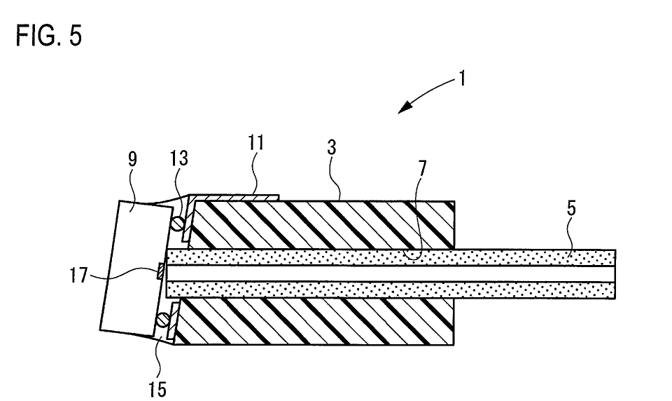

FIG. 6 is a production step diagram illustrating a method of assembling the conventional optical module shown in FIG. 5.

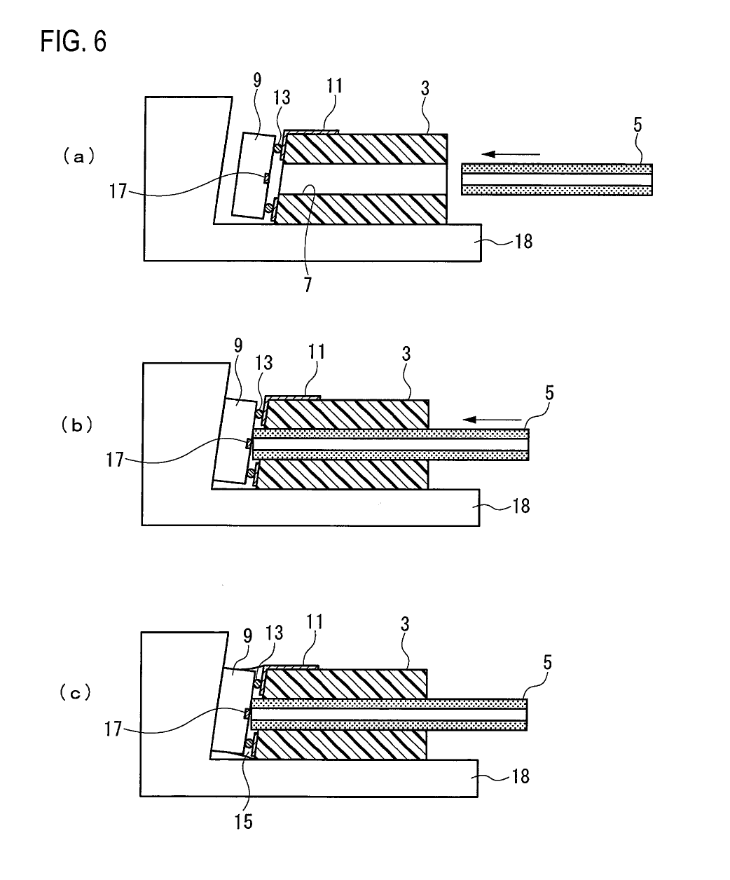

FIG. 7 is a side view illustrating a method of cutting the optical fiber.

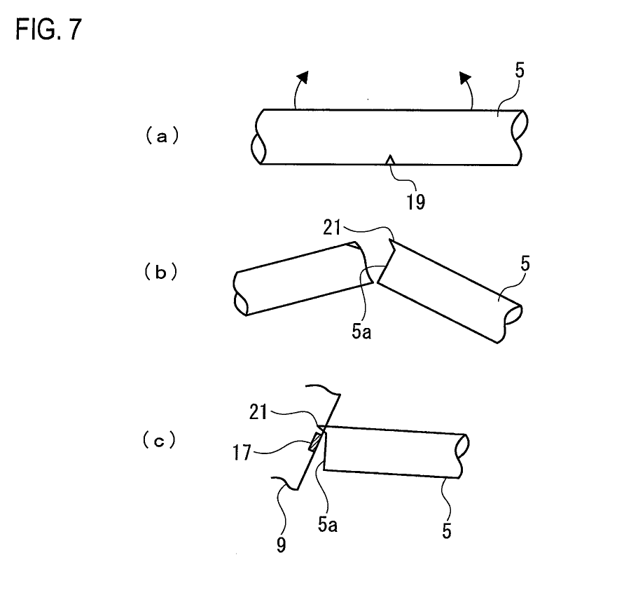

### MODE FOR CARRYING OUT THE INVENTION

Hereinafter, a preferred embodiment of the optical module and method of assembling it according to the invention will be described with reference to the drawings.

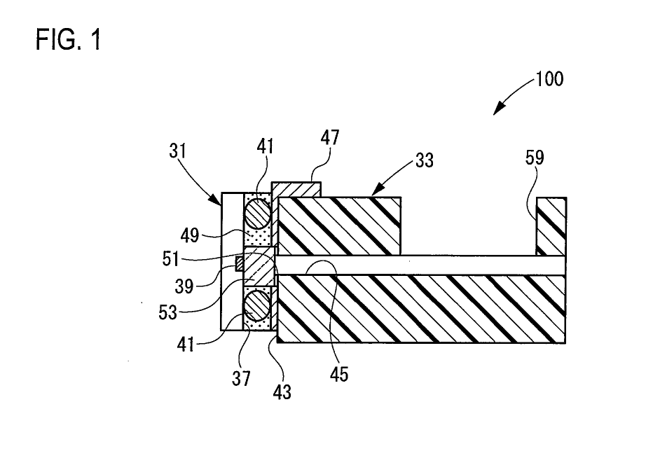

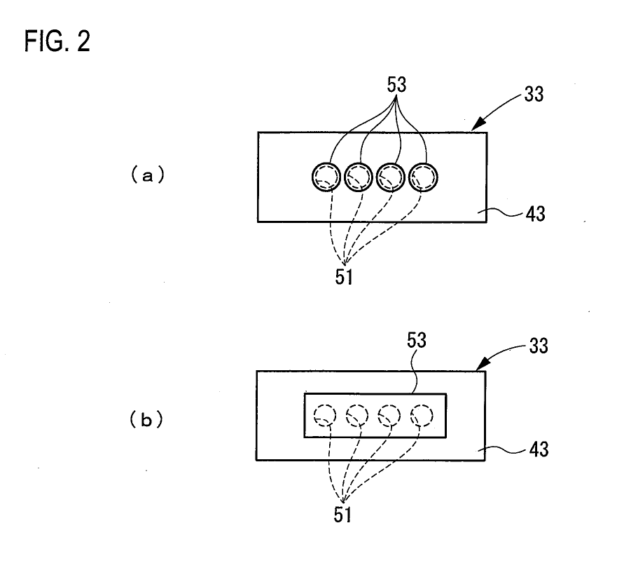

FIG. 1 is a sectional view of the optical module of the invention, and FIG. 2 is a front view showing in (a) and (b) an example of a transparent substance which is attached to one end face of the optical module shown in FIG. 1.

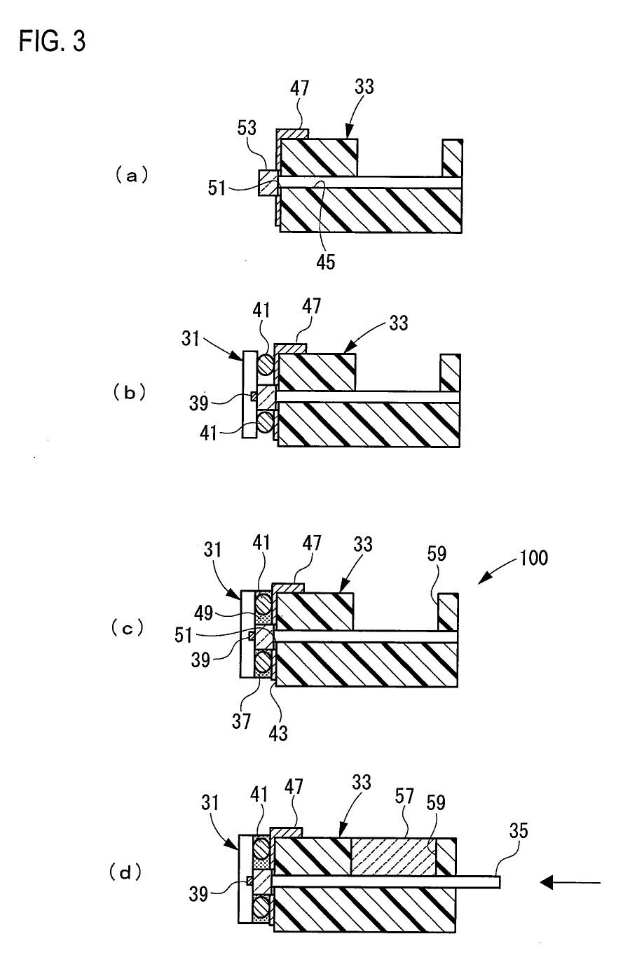

The optical module 100 constitutes a later-optical-fiber-assembling optical module which includes a photoelectric converting element 31 and a lead-insert molded ferrule (hereinafter, referred to simply as “optical ferrule”) 33. Alternatively, the optical module of the invention may constitute an optical-fiber-assembled optical module which includes optical fibers (see FIG. 3) 35 as described later.

As the photoelectric converting element 31, for example, a VCSEL, a PD (photodiode), or the like is used. A plurality of active layers 39 are placed in a coupling face 37 of the photoelectric converting element 31. The active layers 39 uses a plurality of Au bumps 41 which are arranged along the active layers 39, as connection terminals.

The optical ferrule 33 is formed by a material which contains one of a polyester resin, a PPS resin, and an epoxy resin, and a plurality of optical fiber through holes 45 which position and hold the optical fibers 35 are placed in a coupling face 43 in accordance with the active layers 39. Extraction electrodes 47 which are a plurality of electric circuits connected to the bumps 41 are juxtaposed on the coupling face 43 of the optical ferrule 33. The electrodes 47 are continuously formed while extending to an intersecting face which is adjacent to the coupling face 43.

The bumps 41 of the photoelectric converting element 31 are fixed to the electrodes 47 of the optical ferrule 33. The fixation can be performed by thermal pressure bonding using an ultrasonic wave. In the optical module 100, the upper face is mounted on a circuit board or the like so that the electrodes 47 are contacted therewith, thereby enabling the photoelectric converting element 31 to perform easy electric supply and signal fetching through the electrodes 47. The optical fibers 35 (see FIG. 3) that are inserted into the optical fiber through holes 45 of the optical ferrule 33 in which the photoelectric converting element 31 is equipped on the coupling face 43 are optically connected to the active layers 39 of the photoelectric converting element 31. A resin material (adhesive agent) 49 is filled and cured between the photoelectric converting element 31 and the coupling face 43 of the optical ferrule 33. Namely, the photoelectric converting element 31 is fixed to the optical ferrule 33 by the bumps 41 and the resin material 49. The invention is characterized in the resin material filled structure in the gap between the photoelectric converting element 31 and the optical ferrule 33.

Namely, opening portions 51 of the optical fiber through holes 45 which are formed in the coupling face 43 of the optical ferrule 33 are covered by a transparent substance 53 which is contacted with the active layers 39 to block intrusion of the resin material 49. The transparent substance 53 may be a sheet or grease. The use of a sheet or grease as the transparent substance 53 facilitates a disposing (attaching) work of attaching the transparent substance 53 to the opening portions 51. Namely, when the substance is a sheet, easy attachment due to an adhesive layer is enabled. When the substance is grease, easy attachment due to application is enabled. When a sheet or grease is used as the transparent substance 53, an impact in an inserting and assembling process can be absorbed by its elasticity. Examples of the material of the sheet are acrylics, silicones, styrenes, olefins, epoxies, polyimide, polyester, polycarbonate, polysulfone, and polyethersulfone. As the grease, silicones may be used.

Hereinafter, a case where the transparent substance 53 is a sheet will be described. As shown in FIG. 2(a), the sheet 53 may be disposed individually correspondingly on the respective plural optical fiber through holes 45. When the sheet 53 is individually disposed, spaces are formed between the sheets 53, and the spaces are filled with the resin material 49. Therefore, the bonding area between the photoelectric converting element 31 and the optical ferrule 33 can be increased, and the fixing strength can be enhanced.

As shown in FIG. 2(b), alternatively, the sheet 53 may be commonly disposed on the plural optical fiber through holes 45. The plurality of optical fiber through holes 45 can be covered at one time by one sheet 53, and the assembling work is facilitated.

As disclosed in Patent Reference 1, preferably, the sheets 53 have a function of suppressing return optical noise. When the refractive index of the sheets 53 is made coincident with that of the optical fibers 35, reflected light from the interface can be reduced, the noise level of the VCSEL can be lowered, and stable optical transmission can be performed.

Preferably, the resin material 49 is an adhesive agent into which an adjusting grain material that suppresses the coefficient of thermal expansion is mixed. When the mixing rate of the resin material 49 and the adjusting grain material is adjusted so that the average or equivalent thermal expansion characteristics of the resin material 49 conform to those of the optical fiber 35 and the photoelectric converting element 31 or are defined as their intermediate value, a thermal stress (thermal strain) relieving effect can be enhanced.

The optical module 100 may be configured so that the bumps 41 of the photoelectric converting element 31 are passed through the sheet 53 and electrically connected to the electrodes 47 formed on the coupling face 43 of the optical ferrule 33. According to the configuration, the position where the sheet 53 is attached is not restricted, and the workability is improved. For example, the sheet 53 can be attached to the whole area of the coupling face 43 of the optical ferrule 33. In this case, the resin material 49 is disposed so as to cover the gap between the photoelectric converting element 31 and the optical ferrule 33.

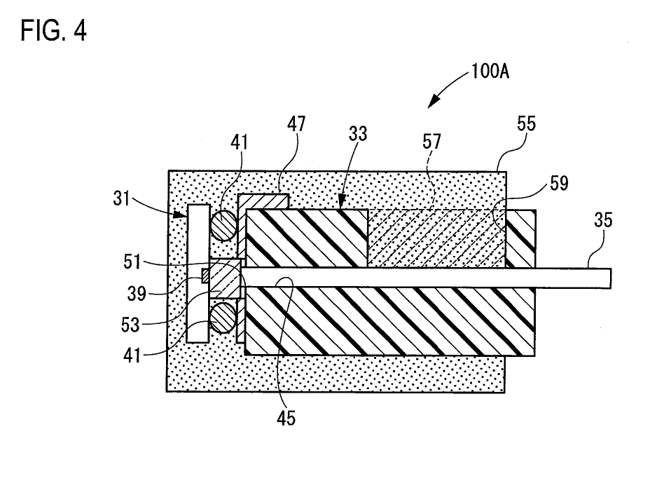

The whole of the photoelectric converting element 31, a part of at least the optical ferrule 33 including the gap between the photoelectric converting element 31 and the optical ferrule 33, and an optical fiber positioning part can be covered by the resin material 49 or a mold resin 55 (see FIG. 4). In the illustrated example, the mold resin 55 functions also as the optical fiber positioning part. The optical fiber positioning part may be a dedicated fixing block 57 or the like. In this case, the fixing block 57 is fixed by the mold resin 55. In this way, the mold resin 55 covers over the photoelectric converting element 31, the optical ferrule 33, and the optical fiber positioning part (fixing block 57), and the photoelectric converting element 31, the optical ferrule 33, and the optical fibers 35 are formed into an integral fixed structure which is stronger.

FIG. 4 shows an optical-fiber-assembled optical module 100A in which the optical fibers 35 are inserted. Alternatively, the integral molded structure by the mold resin 55 may be applied to the later-optical-fiber-assembling optical module 100 as shown in FIG. 1. In this case, the mold resin 55 is molded excluding an attachment opening 59 (see FIG. 1) for the fixing block 57.

The mold resin 55 may be used also as the resin material 49. According to the configuration, while the single resin material 49 is used, filling of the gap between the photoelectric converting element 31 and the optical ferrule 33, and mold covering over the photoelectric converting element 31 and the optical ferrule 33 are enabled, and the kinds of used resin materials, and the number of production steps can be reduced.

In the above-described optical module 100, therefore, the chip reinforcement resin material 49 which is to be applied in a post process can be prevented from intruding into the optical paths. Since the sheets 53 are contacted with the active layers 39 to cover the opening portions 51, the optical paths are previously ensured between the optical fibers 35 and the active layers 39, and the chip reinforcement resin material 49 is not required to have transparency.

As described above, the optical module 100 may be configured as the optical-fiber-assembled optical module 100A in which the optical fibers 35 are inserted into the optical fiber through holes 45. In this case, as the optical fibers 35, quartz multi-mode GI (Grand Index) fibers, multi-component glass optical fibers, or plastic optical fibers can be used. The highly reliable optical-fiber-assembled optical module 100A is obtained in which the optical fibers 35 butt against the active layers 39 through the sheets 53, and the active layers 39 are not broken by butting of the tip ends of the optical fibers.

According to the above-described optical module 100, the openings 51 of the optical fiber through holes 45 which are formed in the coupling face 43 of the optical ferrule 33 are covered by the sheets 53 that are contacted with the active layers 39 to block intrusion of the resin material 49, and hence the chip reinforcement resin material 49 which is to be applied in a post process can be prevented from intruding into the optical paths. For the purpose of ensuring the reliability, the resin material 49 contains the adjusting grain material which suppresses the coefficient of thermal expansion, and, in view of ensuring a high reliability, is not required to be transparent. Therefore, the degree of freedom in material selection is enhanced.

Since the sheets 53 are interposed between the active layers 39 and the opening portions 51, the photoelectric converting element 31 can be fixed by the highly reliable resin material 49 while ensuring the transparency of the optical paths. Since the sheets 53 are disposed in the opening portions 51, element breakage caused by butting of the optical fibers 35 against the active layers 39 can be prevented from occurring, even when the optical module is used as the later-optical-fiber-assembling optical module 100A into which the optical fibers 35 are to be inserted by the user.

Next, a method of assembling the above-described optical module will be described.

FIG. 3 is a production step diagram illustrating a method of assembling the optical module shown in FIG. 1, and FIG. 4 is a sectional view of a modification in which a resin material is used as the mold resin.

When the optical module 100 is to be assembled, the opening portions 51 of the optical fiber through holes 45 which are formed in the coupling face 43 of the optical ferrule 33 are first covered by the sheets 53 as shown in FIG. 3(a).

Next, as shown in FIG. 3(b), the photoelectric converting element 31 is connected and fixed to the coupling face 43 of the optical ferrule 33.

When the photoelectric converting element 31 is fixed, the resin material 49 is filled between the photoelectric converting element 31 and the coupling face 43 of the optical ferrule 33 as shown in FIG. 3(c).

As a result, the assembling of the later-optical-fiber-assembling optical module 100 is completed.

In assembling of the optical-fiber-assembled optical module 100A, successively, the optical fibers 35 are inserted into the optical fiber through holes 45 as shown in FIG. 3(d).

After the optical fibers 35 are inserted, the fixing block 57 is attached to the attachment opening 59 to fix the optical fibers 35. As required, covering of the mold resin 55 is performed to complete the assembling of the optical-fiber-assembled optical module 100A shown in FIG. 4.

According to the method of assembling an optical module, even when the resin material 49 is filled, the resin material 49 is blocked by the sheets 53, and does not intrude into the optical fiber through holes 45. Since the opening portions 51 are covered by the sheets 53, the filling of the resin material 49 can be performed without regard to the intrusion, and a high fixation strength can be obtained. Furthermore, it is possible to obtain the highly reliable optical-fiber-assembled optical module 100A in which the optical fibers 35 butt against the active layers 39 through the sheets 53, and the active layers 39 are not broken by butting of the tip ends of the optical fibers. In the optical-fiber-assembled optical module 100A which is covered by the mold resin 55, the photoelectric converting element 31, the optical ferrule 33, and the optical fibers 35 can be formed into an integral fixed structure which is stronger.

According to the method of assembling an optical module, therefore, it is possible to obtain the later-optical-fiber-assembling optical module 100 in which the photoelectric converting element 31 is fixed by the highly reliable resin material 49 while ensuring the transparency of the optical paths.

As a method of assembling the optical-fiber-assembled optical module 100A, a method may be employed in which, instead of insertion of the optical fibers 35 into the optical fiber through holes 45 of the later-optical-fiber-assembling optical module 100 in which the above-described assembly has been completed, a step of inserting the optical fibers 35 into the optical fiber through holes 45 of the optical ferrule 33 which is shown in FIG. 3(b), and to which the photoelectric converting element 31 is connected and fixed is performed, and thereafter a step of covering the whole of the photoelectric converting element 31, and a part of at least the optical ferrule 33 including the gap between the photoelectric converting element 31 and the coupling face 43 of the optical ferrule 33, by the mold resin 55 is performed, thereby completing the assembling.

Although the invention has been described in detail and with reference to the specific embodiments, it is obvious to those skilled in the art that various changes and modifications can be made without departing from the spirit and scope of the invention. The application is based on Japanese Patent Application (No. 2008-098139) filed Apr. 4, 2008, and its disclosure is incorporated herein by reference.

### DESCRIPTION OF REFERENCE NUMERALS AND SIGNS

31 . . . photoelectric converting element, 33 . . . optical ferrule, 35 . . . optical fiber, 39 . . . active layer, 41 . . . bump, 43 . . . coupling face (one end face), 45 . . . optical fiber through hole, 47 . . . electrode, 49 . . . resin material, 51 . . . opening portion, 53 . . . sheet (transparent substance), 55 . . . mold resin, 57 . . . fixing block (optical fiber positioning part), 100 . . . optical module

1. An optical module including: a photoelectric converting element; and an optical ferrule in which said photoelectric converting element is equipped on one end face, and an optical fiber through hole is passed and formed at a position corresponding to an active layer of said photoelectric converting element, a resin material being filled and cured between said photoelectric converting element and said optical ferrule, wherein an opening portion of said optical fiber through hole is covered by a transparent substance which is contacted with said active layer, and which blocks intrusion of the resin material, said opening portion being formed in the one end face of said optical ferrule.

2. An optical module according to claim 1, wherein
the transparent substance is a sheet or grease.

3. An optical module according to claim 2, wherein
said optical fiber through hole is formed in plural, and said sheet or said grease is disposed individually correspondingly on said respective plural optical fiber through holes.

4. An optical module according to claim 2, wherein
said optical fiber through hole is formed in plural, and said sheet or said grease is commonly disposed on said plural optical fiber through holes.

5. An optical module according to claim 1, wherein
an optical fiber is passed through said plural optical fiber through hole.

6. An optical module according to claim 1, wherein
bumps of said photoelectric converting element are passed through the transparent substance and electrically connected to electrodes which are formed on the one end face of said optical ferrule.

7. An optical module according to claim 1, wherein
the resin material is an adhesive agent into which an adjusting grain material that suppresses a coefficient of thermal expansion is mixed.

8. An optical module according to claim 1, wherein
a whole of said photoelectric converting element, and a part of at least said optical ferrule including a gap between said photoelectric converting element and said optical ferrule are covered by a mold resin.

9. An optical module according to claim 9, wherein
the mold resin is the resin material.

10. A method of assembling an optical module, wherein said method performs the steps:
covering an opening portion of an optical fiber through hole formed in one end face of said optical ferrule, by a transparent substance;
connecting and fixing a photoelectric converting element to the one end face of said optical ferrule; and
filling a resin material between said photoelectric converting element and the one end face of said optical ferrule.

11. A method of assembling an optical module, wherein said method performs the steps:
covering an opening portion of an optical fiber through hole formed in one end face of said optical ferrule, by a transparent substance;
connecting and fixing a photoelectric converting element to the one end face of said optical ferrule;
inserting an optical fiber into said optical fiber through hole; and
covering a whole of said photoelectric converting element, and a part of at least said optical ferrule including a gap between said photoelectric converting element and said optical ferrule, by a mold resin.
